(19) United States
(12) Patent Application Publication
(10) Pub. No.: US 2010/0042826 A1
(43) Pub. Date: Feb. 18, 2010

(54) Dynamic Control of Device State Based on Detected Environment

(75) Inventors: William Bull, Mountain View, CA (US); Policarpo Wood, San Francisco, CA (US); Kourtny Minh Hicks, Sunnyvale, CA (US); Benjamin Andrew Rottler, Burlingame, CA (US); Eric James Hope, Cupertino, CA (US); Alan Cannistraro, San Francisco, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple Inc., Cupertino, CA (US)

(21) Appl. No.: 12/192,937

(22) Filed: Aug. 15, 2008

(51) Int. Cl. G06F 1/24

(52) U.S. Cl. 713/100

(57) ABSTRACT

Techniques for automatically adjusting device preferences (e.g., playback settings of a PMD) based the on the device's environment. The environment may be characterized, for example, by one or more of the location of the device, the accessories connected to the device, and/or the state of wireless signals detected by the device. The device stores different states associated with different environments, and loads the appropriate state variables based on the detected environment. For example, when connecting to a given speaker system resumption of audio playback can be from the last track or playlist being played on that speaker system.

### BACKGROUND OF THE INVENTION

The present invention relates generally to configuring electronic devices, and more specifically to configuring portable devices such as media devices (“PMDs”).

Media assets, such as audio tracks, video tracks, or images (e.g., photos) can be stored, displayed, and/or played on a portable media device (“PMD”) or on a host computer executing a media management application (“MMA”). Often, a portable media device acquires its media assets from a host computer executing an MMA, and the user may use the MMA to organize the collection of media assets. One example of a PMD may be the iPod® portable media device, currently available from Apple Inc. of Cupertino, Calif. One example of an MMA may be iTunes® media management application, produced by Apple Inc. Some PMDs provide the user a display to aid in interacting with the content on the PMD.

As the popularity of PMDs has grown, so too has the proliferation of accessories for augmenting the functionality of the PMDs. Furthermore, PMDs have been evolving to include additional features and increased configurability. The ability to store a large music collection has resulted in many users relying on their PMDs as their primary music source, whether at home, at work, in the car, or while engaging in outdoor activities. Various of the accessories have been developed to enhance the user's experience in the different environments.

Since many PMDs do not have built-in speakers, earphones and other forms of external speakers make up a significant portion of the accessory population. Other accessories include microphones, car stereo adapters, wireless adapters, and the like.

All but the very simplest PMDs have a set of user-settable operating parameters, sometimes referred to as settings or preferences. A set of preferences will normally be saved in non-volatile storage so as to be available the next time the device is powered up. For example, a PMD model referred to as the iPod® Classic includes the capability of allowing a user to set preferences relating to shuffle, repeat, items for main menu, items for music menu, volume limit, backlight, display brightness, audiobooks, equalizer, sound check, clicker, date and time, and sort order (for contacts). This set of configuration parameters is merely exemplary. Other models of iPod® PMDs and PMDs from other manufacturers can have different sets of settings parameters.

### SUMMARY OF THE INVENTION

Embodiments of the present invention recognize and address the issue of users' constantly needing to reconfigure their electronic devices, including portable devices (such as laptops, portable phones, PDAs, and PMDs, or devices providing the functionality of multiple such devices), when they use them in different environments. Due to the inherent mobility of PMDs, they can be used in different environments, and the need to constantly reconfigure them, while possibly inconvenient, has been accepted as inevitable.

In addition to media assets, a PMD can provide the user with the ability to manage other stored content, such as contacts, calendar events. This can be especially relevant for those PMDs that are integrated with a phone. Although much of the discussion and examples will deal with managing and playing musical selections, embodiments of the invention are applicable to other media assets or stored content.

Embodiments of the invention operate to save multiple states of a device such as a PMD in response to multiple designated environments. Embodiments of the present invention can associate a device configuration or state with each listed environment. A given state may be characterized by a set of values of a set of state parameters and a given environment may be characterized by a set of values of a set of environmental parameters. In an example where the device is a PMD, the state information can include at least one state parameter relating to audio output. However, some non-portable devices also have states and some can provide audio output. Further, some portable devices cannot provide audio output. Thus, the invention is not limited to portable devices, or devices that can play audio.

In this context, the term “state” parameters is used to denote the set of operating parameters of the device, and generally can be considered to encompass either or both of two types of information, referred to here as settings information and status information. Settings information refers to the values of the settings parameters while status information refers to the values of status parameters.

The use of “settings” here is intended to cover generally what are referred to as settings or preferences in many known hardware and software contexts. These are parameters with user-settable values that are intended to persist through power down cycles until changed by the user. Examples of settings were mentioned above in the Background section.

The use of “status” here is intended to cover more transitory aspects of the device state. These can depend on the way that the device is being used at a given moment. For example, the status of a PMD can be characterized by one or more of current volume, current track, or current place in track.

The use of “environment” here is intended to cover the effects of external entities on the device. For example, a given environment may be characterized by one or more of the location of the device, the accessories connected to the device, and/or the state of wireless signals detected by the device. The term “environment” is not, however, intended to cover whether the device is running on an internal battery or is attached to an external power supply (e.g., an AC adapter, a powered USB or Firewire port, or an auxiliary battery). The adjective “non-power” is used in connection with parameters or signals, for example, to mean parameters or signals that refer to or contain information other than information regarding the power status of the device. For example, the battery level is a not a non-power state parameter, parameters characterizing the source of power are not non-power state parameters, and signals indicating whether there is an external power source are not non-power signals. Thus, for example, the battery level and other parameters characterizing the source of power are not considered environmental parameters.

In an aspect of the invention, a method of establishing an operating state of a portable device comprises: receiving, at an interface of the device, a non-power signal provided by an entity outside the device, the signal containing identifying information; and in response to the signal, using the identifying information to determine whether there exists previously stored state information that is associated with information matching the identifying information.

In this aspect, the method can further comprise, in response to determining that there exists previously stored state information that had been associated with information matching the identifying information, reconfiguring the device in accordance with the stored state information. In the same or different embodiments, the method can further comprise, in response to determining that there does not exist previously stored state information that had been associated with information matching the identifying information, storing current state information in association with information matching the identifying information.

In another aspect of the invention, a method performed by a device that is capable of determining an environment comprises: determining a current environment for the device; determining whether the current environment matches a most recently stored environment; if no, then (a) determining whether there is stored state information that is associated with the current environment, and (b) if there is stored state information, reconfiguring the device in accordance with the stored state information that is associated with the current environment.

In this aspect, the method can further comprise, if it is determined that there is no stored state information that is associated with the current environment, then prompting the user whether to associate state information with the current environment, and (a) if the user specifies associating state information with the current environment, storing state information in association with the current environment, or (b) if the user specifies not associating state information with the current environment, maintaining the current state without storing state information associated with the current environment.

In another aspect of the invention, a method of establishing an operating state of a device, where the operating state is characterized by a set of one or more state parameters, comprises: while in a current operating state, in response to detecting the presence of an accessory coupled to an accessory interface of the device, determining identifying information that characterizes the accessory; using the identifying information to determine whether there exists a previously stored operating state that had been associated with information matching the identifying information; and in response to determining the existence of such a previously stored operating state, changing at least those state parameters that differ between the current operating state and the previously stored operating state.

In another aspect of the invention, a portable device comprises: a storage medium; a processor coupled to the storage medium; an interface for receiving non-power signals provided by entities outside the device, where the signals contain identifying information; a plurality of state information constructs stored in the storage medium, the state information constructs representing operating states for the device, where each state information construct is associated with one or more sets of identifying information; and computer code stored in the storage medium where the computer code, when retrieved from the storage medium and executed by the processor, uses identifying information in signals at the interface to determine whether any state information constructs in the storage medium are associated with information matching the identifying information.

In this aspect, the device's computer code can further, in response to determining that the storage medium includes one or more state information constructs that are associated with information matching the identifying information, reconfigure the device's operating state in accordance with at least a state parameter value stored in one or more of those one or more state information constructs.

In this aspect, the device's computer code can further, in response to determining that the storage medium does not include one or more state information constructs that are associated with information matching the identifying information, create a state information construct with at least one state parameter value corresponding to a current operating state, and associate that state information construct with information matching the identifying information.

In another aspect of the invention, a device comprises: a storage medium; an interface for receiving non-power signals provided by entities outside the device; state information stored in the storage medium, the state information representing a plurality of device operating states associated with a plurality of device environments; and a controller coupled to the storage medium

In this aspect, the controller is configured to: determine, based on non-power signals received at the interface, a current environment for the device; determine whether the current environment matches a most recently stored environment; and if the current environment does not match the most recently stored environment, then determine whether there is stored state information that is associated with the current environment, and if it is determined that there is stored state information that is associated with the current environment, reconfigure the device in accordance with the stored state information that is associated with the current environment.

In this aspect, the controller can be further configured, if it is determined that there is no stored state information that is associated with the current environment, to: prompt the user whether to associate state information with the current environment, and if the user specifies associating state information with the current environment, store state information in association with the current environment; if the user does not specify associating state information with the current environment, maintain the current state without storing state information associated with the current environment.

In another aspect of the invention, a portable media device having operating states comprises: a storage medium; an interface for receiving non-power signals provided by entities outside the device; state information stored in the storage medium, the state information representing a plurality of device operating states associated with a plurality of device environments; and a controller coupled to the storage medium.

In this aspect, the controller is configured to: while in a current operating state, in response to detecting the presence of an accessory coupled to an accessory interface of the device, determine identifying information that characterizes the accessory; use the identifying information to determine whether there exists a previously stored operating state that had been associated with information matching the identifying information; and in response to determining the existence of such a previously stored operating state, change at least those state parameters that differ between the current operating state and the previously stored operating state.

In other aspects of the invention, a computer-readable medium contains program instructions, which when executed by a computer system in a portable device cause the computer system to execute a method of establishing an operating state of the portable device. In these aspects of the invention, the method can be one of the methods described above in connection with other aspects of the invention.

In embodiments relating to any of the above methods, apparatus, or computer-readable media, the signal may be received from an accessory coupled to the interface of the device, from an accessory having a wireless transmitter, from one or more remote wireless transmitters, and/or from a wireless network. In such cases, the identifying information includes a characteristic of the accessory, information that provides the device the ability to determine the device's location, and/or a characteristic of the network, as the case may be.

In embodiments relating to any of the above methods, apparatus, or computer-readable media, where the device further comprises a connector coupled to the interface, at least some of the signals at the interface are received from an accessory coupled to the connector, and the identifying information for those signals includes a characteristic of the accessory.

In embodiments relating to any of the above methods, apparatus, or computer-readable media, where the device further comprises an antenna coupled to the interface, at least some of the signals at the interface are received by the antenna from an accessory having a wireless transmitter, and the identifying information for those signals includes a characteristic of the accessory. Alternatively, or in addition, at least some of the signals at the interface are received by the antenna from one or more remote wireless transmitters, and the identifying information for those signals includes information that provides the device the ability to determine the device's location. Alternatively, or in addition, at least some of the signals at the interface are received by the antenna from a wireless network, and the identifying information for those signals includes a characteristic of the network.

In embodiments relating to any of the above methods, apparatus, or computer-readable media, there can be an accessory and/or a connector and/or an antenna coupled to the interface. A method can, or a device controller can be configured to, determine a current environment for the device by: detecting signals at the interface of the device; determining whether there is an accessory coupled to the interface; and if there is an accessory coupled to the interface, incorporating information about the accessory into at least one environmental parameter.

Alternatively, or in addition, a method can, or a device controller can be configured to, determine a current environment for the device by: detecting wireless signals from one or more remote wireless transmitters at an antenna of the device; determining whether the wireless signals contain information that provides the device the ability to determine the device's location; and if the wireless signals provide such information, incorporating information about the device's location into at least one environmental parameter.

Alternatively, or in addition, a method can, or a device controller can be configured to, determine a current environment for the device by: detecting wireless signals from one or more remote wireless transmitters at an antenna of the device; determining whether the wireless signals contain information regarding a wireless network; and if the wireless signals provide such information, incorporating information about the wireless network into at least one environmental parameter.

A further understanding of the nature and advantages of the present invention may be realized by reference to the remaining portions of the specification and the drawings.

### BRIEF DESCRIPTION OF THE DRAWINGS

FIG. 1A is a block diagram of a device according to an embodiment of the present invention;

FIGS. 1B, 1C, and 1D are block diagrams of devices such as the device of FIG. 1A in different environments;

FIG. 2A is a front view of a portable media device (“PMD”) or similar device according to an embodiment of the present invention, and further includes a balloon view of media assets and state information that can be stored in the PMD;

FIG. 2B is a top view of the PMD shown in FIG. 2A;

FIG. 2C is a bottom view of the PMD shown in FIG. 2A;

FIG. 3 is a flowchart showing representative scenarios that can occur during operation of an embodiment of the present invention;

FIG. 4 is a is a flowchart showing additional scenarios that can occur during operation of an embodiment of the present invention;

FIG. 5 is a is a simplified schematic of a possible database arrangement for an embodiment of the present invention; and

FIG. 6 is a is a block diagram of a device according to an embodiment of the present invention.

### DESCRIPTION OF SPECIFIC EMBODIMENTS

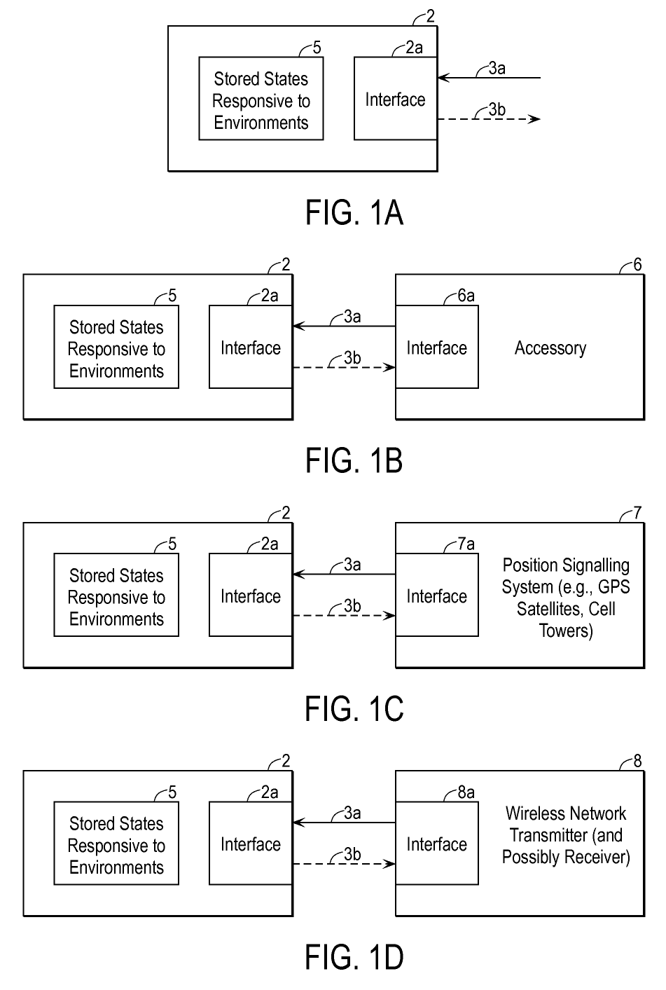

FIG. 1A is a block diagram of a device 2 according to an embodiment of the present invention. Device 2 has an interface 2a at which it receives signals 3a; in some embodiments, interface 2a is bidirectional so that device 2 can send signals 3b using the interface. Signals 3a can include information, and in accordance with embodiments of the present invention, device 2 stores a number of device states that are associated with different sets of information in those signals. This is shown schematically as a block 5 captioned “Stored States Responsive to Environments.” Upon receiving such signals, device 2 can check whether any of its stored states corresponds to the signal information.

If the device finds that it has a stored state corresponding to the signal information, the device can reconfigure itself in response to finding such a stored state (i.e., the device can set its current state to the previously stored state). If the device does not find a stored state corresponding to the signal information, it can store its current state in association with the signal information. FIGS. 1B, 1C, and 1D are block diagrams of devices such as the device of FIG. 1A receiving different types of signals at interface 2a.

FIG. 1B shows device 2 in communication with an accessory 6 having an interface 6a. The accessory has the capability of identifying itself by communicating with device 2 via the respective interfaces 6a and 2a. The communication can be unidirectional or bidirectional, and can be over direct connections or over a wireless channel. For example, accessory can encode identifying information on signals 3a, either spontaneously, or in response to an interrogation message encoded on signals 3b. Based on this identifying information, device 2 can check whether any of its stored states corresponds to the identifying information from accessory 6. If such stored information exists, the device can set its current state to the previously stored state. Representative scenarios will be described below.

FIG. 1C shows device 2 in communication with a position signaling system 7 having an interface 7a. System 7 includes an entity or entities that can generate signals that, when processed by suitable circuitry in device 2, provide device 2 with information regarding its position. These signals are typically wireless signals. Position signaling system 7 can include a global navigation satellite system (e.g., GPS) having global positioning satellites that provide autonomous geo-spatial positioning signals. Alternatively, or in addition, position signaling system can include a plurality of cellular towers the signals from which allow position sensing by means of triangulation or RF fingerprint analysis. Based on position information, device 2 can check whether any of its stored states corresponds to the position information gleaned from position signaling system 7. If such stored information exists, the device can set its current state to the previously stored state. Representative scenarios will be described below.

FIG. 1D shows device 2 in communication with a wireless network transmitter 8 having an interface 8a. The wireless network transmitter can also have an associated wireless network receiver for bidirectional communications. Device 2 can obtain information regarding the wireless network, and check whether any of its stored states corresponds to the wireless network. If such stored information exists, the device can set its current state to the previously stored state. Representative scenarios will be described below.

Thus, embodiments of the present invention provide enhancements to the automatic configuration of electronic devices in response to changes in environment. The possibilities shown in FIGS. 1B, 1C, and 1D underscore the fact that embodiments of the present invention can be deployed in a wide variety of environments. While much of the description below refers to a portable device such as a portable media device (“PMD”), there is no need to consider the invention to be limited to portable devices, much less PMDs. Rather, embodiments of the present invention can find applicability to any device that is characterized by state parameters.

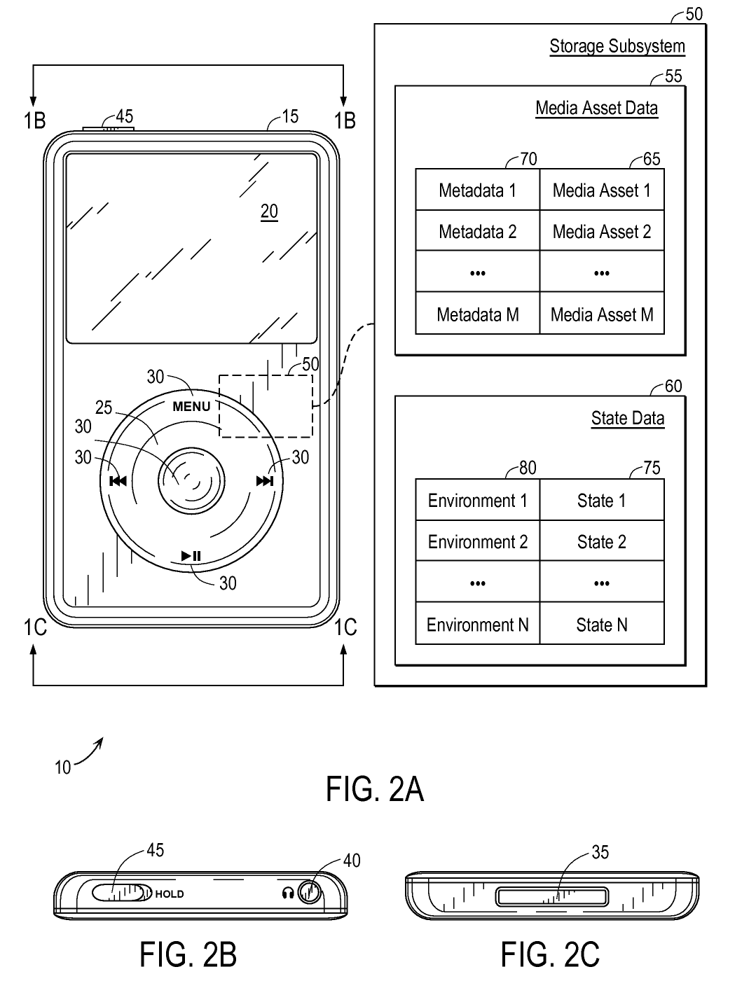

FIGS. 2A, 2B, and 2C are respective front, top, and bottom views of a PMD 10 or similar device according to an embodiment of the present invention. FIG. 2A further includes a balloon view of media assets and state information that can be stored in the PMD. For concreteness, the description of PMD 10 will be in terms of a device that, among other things, plays music. PMDs such as Apple's iPod® devices are examples of devices in which embodiments of the present invention can be implemented. Components of PMD 10 may be hidden inside, or visible from outside, a housing 15.

Components disposed outside the housing or disposed to be visible outside the housing can include a display 20, one or more user input devices such as a scroll wheel 25 and buttons 30, one or more I/O connectors such as an accessory interface connector 35 and an audio out connector 40, and one or more switches such as a hold switch 45. The specific PMD includes four buttons denoted by respective text or graphical legends (“Menu”, Play/Pause, Forward, Backward), and a fifth button, which is not marked and can be used for selecting items. In the context of an iPod® device, scroll wheel 25 and buttons 30 are collectively referred to as a “click wheel.” These components communicate with circuitry and components (not generally shown in FIG. 2A) that are disposed inside housing 15. Included among the components disposed inside housing 15 is a storage subsystem 50 (shown in phantom).

Also shown in FIG. 2A is a balloon view of a portion of the data stored in storage subsystem 50. In the specific embodiment of a PMD, media assets can be stored in storage subsystem 50, and are shown schematically in FIG. 2A's balloon view of storage subsystem as a media asset data structure 55. In accordance with various embodiments of the present invention, certain state information pertaining to PMD 10 can also be stored in storage subsystem 50 and is shown in FIG. 2A's balloon view as a state data structure 60. These data structures and their respective data will be described in greater detail below.

While a specific PMD is shown in FIGS. 2A, 2B, and 2C, the drawing could also have been drawn as a black box with a connector and/or another mechanism for receiving signals or detecting an environment. The details of PMD 10 beyond this are exemplary of a particular class of device that can benefit from embodiments of the present invention. PMD 10 is a possible instance of device 2 shown in FIGS. 1A-1D, which can take on many other forms. Similarly, state data structure 60 is a possible instance of stored states 5 shown in FIGS. 1A-1D.

Media assets are sometimes referred to simply as assets. The term “asset” can be broader in some contexts, including for example contacts, appointments, or descriptions of personal possessions. It is contemplated that the assets may change from time to time. The media assets are shown schematically as media asset data 55 containing one or more media assets 65 (shown with indices 1 . . . M) with associated sets of metadata 70 (shown with indices 1 . . . M).

Media assets 65 can include any type of media content that can be stored in digital form and experienced by a user. Examples include music, podcasts, audiobooks, video clips, movies, recorded television or radio broadcasts, photographs, slide shows, other still images, and so on. Where the media assets include music, the individual items are sometimes referred to as “tracks” and certain pre-defined collections of tracks are sometimes referred to as “albums.” User-defined collections of tracks are sometimes referred to as “playlists.”

Metadata 70 can include any data descriptive of one or more characteristics of that asset. For instance, metadata 70 may include inherent attributes of the asset as well as attributes taken on during the time after the asset is first stored in the PMD.

Again, in the context of music tracks and albums, examples of inherent (although possibly changeable by the user) metadata for an asset stored in the PMD can include media type (e.g., music, video, photo, audiobook, podcast, etc.) track ID, track number, track count, track name, artist, album, genre and sub-genre classification, digital encoding information (encoding algorithm, bit rate, sample rate), size, total time, date modified, date added, persistent ID, track type, file type, file creator, location. Some of the metadata may have been generated at the time of encoding the media asset itself and may be stored in the media asset file and made available for asset management applications.

Examples of metadata that can be specified by the user, or automatically created and updated based on user actions include user-supplied rating, playlist(s) to which the user has assigned the asset, play count, play date, play date UTC.

Although each media asset and its associated metadata are shown adjacent each other as if each asset/metadata pair formed a record in a flat-file database, other arrangements for associating assets and metadata can be used. For example, the iTunes® media management application (“MMA”) stores the music tracks as individual files in a hierarchical directory structure and the metadata as a single database file, presumably with pointers to the music tracks. Regardless of the structure of the metadata and assets, there is no fundamental reason that every asset have values for all types of metadata. That is, the structure of the metadata for like assets need not be the same for all the assets.

As mentioned above, embodiments of the present invention can operate to store, e.g., in storage subsystem 50, device states, shown schematically as state data 60 containing a plurality of device states 75 (shown with indices 1 . . . N) with associated different device environments 80 (shown with indices 1 . . . N). Although each state and its associated environment are shown adjacent each other as if each state/environment pair formed a record in a flat-file database, other arrangements for associating states and environments can be used. Other arrangements for associating states and environments will be described below.

The term “state” is intended to broadly cover aspects of the device that are subject to change during normal use. In general, a given state 75 can be characterized by the particular values of a set of one or more state parameters. The state parameters can include one or more user-settable parameters (“settings parameters”) that are intended to persist through power down cycles until changed by the user, and one or more parameters whose values may be transitory (“status parameters”) and may depend on the way that PMD 10 is being used at a given moment. In many instances, it will be clear whether something is a settings parameter or a status parameter, but the dividing line is not always bright.

In common parlance, the terms “state” and “configuration” can be used somewhat interchangeably, but configuration is sometimes also used to refer to generally immutable characteristics of a device, such as storage capacity, processor speed, and display size. Since embodiments of the invention operate to store multiple device states characterized by settable or transitory parameter values, the term “state” will be used.

The settings parameters, the particular values of which can at least partially characterize a given device state 75 may include, for example any one or more of shuffle, repeat, items for main menu, items for music menu, volume limit, backlight, display brightness, audiobook play speed, equalizer, sound check, clicker, date and time, and sort order (for contacts), volume control override, and whether the device controls are disabled. The particular mechanisms for setting these parameters will vary, depending on the device. For example, a conventional graphical user interface can be implemented.

The status parameters, the particular values of which can at least partially characterize a given state may include, for example, media selection parameters (e.g., playlist, playlist selection options, current track, or current place in track), output parameters (e.g., current volume), and device context (e.g., displaying particular menu options).

The term “environment” is intended to be broad so as to include a broad range of conditions that might cause a user to reconfigure the device in view of a changed environment. The PMD can detect signals or other conditions originating outside the device, and determine a number of values of environmental parameters. In general, a given device environment 80 can be characterized by the particular values of a set of one or more environmental parameters. In the specific example of a PMD, the environmental parameters can, for example, reflect one or more of the location of the device, the accessory or accessories connected to the device, or characteristics of wireless signals detected by the device.

Additionally, when the device is powered off or detects changes in its environment, the state for the previous environment can be saved. Subsequently, when the device detects a given environment, it can load the previously saved state information associated with (corresponding to) that environment. This can be done automatically in some embodiments. In other embodiments, the device can prompt the user that it has detected an environment change, and can change the state in response to user inputs to the prompts.

In some embodiments, a detected environment is used to search state data 60 for stored state information associated with that environment. There is no requirement that the same sets of state parameters be stored for different environments. Thus, for example, where different sets of state parameters are stored for different environments, the number of state parameters stored for a given environment may differ from environment to environment. Further, in at least some instances, only a small fraction of the state parameters will change value in response to changes in environment. Thus it may not always be necessary to store all the values of all the state parameters for each saved state.

As mentioned above, the term “environment” is not intended to cover whether the device is running on an internal battery or is attached to an external power supply (e.g., an AC adapter, a powered USB or Firewire port, or an auxiliary battery). The use of the adjective “non-power” in connection with parameters or signals, for example, means parameters or signals that refer to or contain information other than information regarding the power status of the device. For example, the battery level is a not a non-power state parameter, parameters characterizing the source of power are not non-power state parameters, and signals indicating whether there is an external power source are not non-power signals. Thus, for example, the battery level and other parameters characterizing the source of power are not considered environmental parameters.

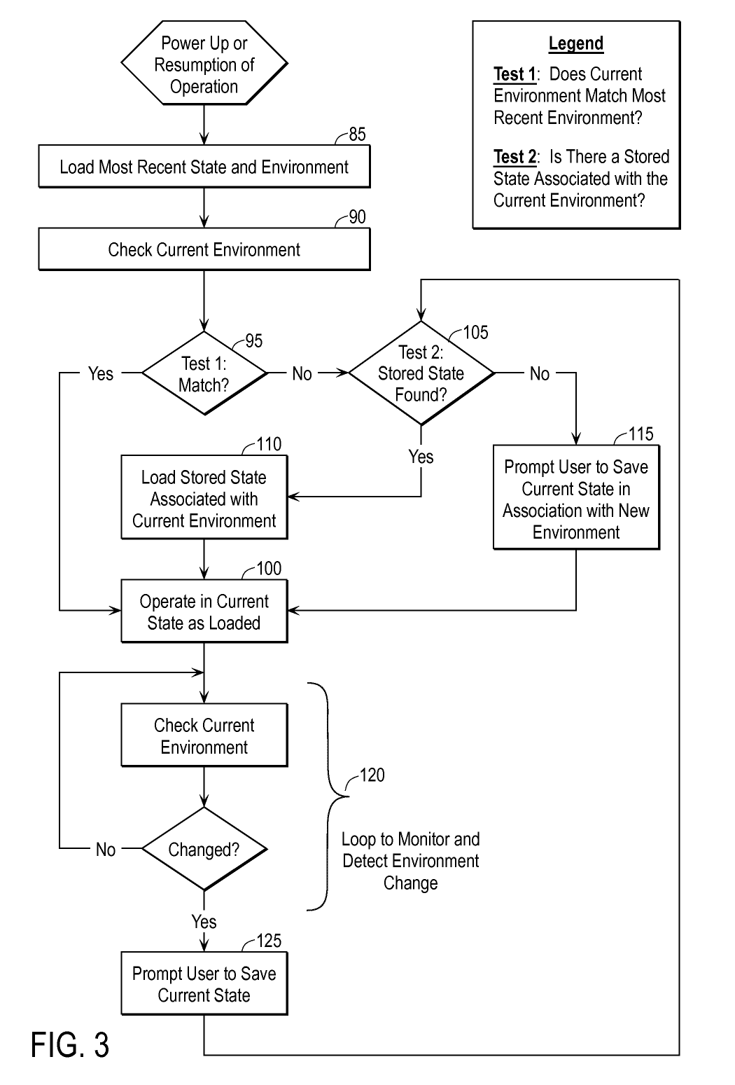

FIG. 3 is a flowchart showing representative scenarios that can occur during operation of an embodiment of the present invention. The top of the flowchart shows the point when the device is powered up or resumes operation after operations were suspended. At a step 85, the device loads the most recent state, i.e., the state that was in effect when the device was last powered down or when operation was suspended. In this context, reference to “loading” the state means that the device commences operation with the values of the state parameters that were stored when the device was most recently operated. This can be a standard operation where at least some of the state parameter values are read from non-volatile storage and written into registers or volatile memory so that the device operates in accordance with the state parameter values.

The device may also load the environment that was associated with the most recent state. In this context, reference to “loading” the environment means that the values of at least some of the environmental parameters are read from non-volatile storage for further use. At this point, no assumptions are made regarding the environment in which the device finds itself, and at a step 90, the device checks its current environment.

As mentioned above, a given stored state has an associated environment. At a step 95, the device determines whether the current environment “matches” the environment that is associated with the current state (i.e., whether the current environment matches the just-loaded environment). In this context, “matching” is used in the sense of meeting a proximity constraint appropriate to the nature of the environments (and possibly the states) that are being checked. For example, if one of the relevant environmental parameters is a unique accessory identifier, matching will typically imply equality. On the other hand, if the one of the relevant environmental parameters is a set of GPS coordinates, matching will typically imply approximate equality (e.g., within 100 yards, even if the coordinates are more precise).

In the context of matching, embodiments can operate with relaxed proximity constraints so that approximate matches are treated as matches. Thus, in these embodiments, if there is no match for an environment characterized by a particular accessory identifier, a match can be considered to exist if there is another environment is characterized by an accessory having similar characteristics. The degree of match required can be established by user preferences, for example. Where this possibility is provided, a user can specify a desire for a close match or an approximate match.

If the environments match, operation proceeds at a step 100 using the current state. If, on the other hand, the environments do not match, a check is made at a step 105 to determine whether there is a previously stored state associated with the current environment. If one exists, the stored state is loaded at a step 110, and thus becomes the current state. If the detected environment does not match an environment for which a state was previously stored, the system prompts the user at a step 115 whether the user wants to change any of the state parameters, and saves a new state record with the state parameters of the just-loaded state (possibly modified by the user) and the current environment. At this point, operation proceeds at step 100.

During normal operation from this point forward, the device can continue to monitor the environment, and take various actions in response to a detected change in the environment (loop 120). In an embodiment, the device can prompt the user at a step 125 to save the current state with the environment before the detected change to account for recent state changes made by the user during normal operation. The device can then branch back to step 105 to determine whether there is a previously stored state record associated with the current (changed) environment.

The embodiment described above can be modified and/or simplified in may respects. For example, as illustrated monitoring loop 120 suggests that the device polls the various components to detect a change in environment. Alternatively, an autonomous process or subsystem can monitor the environment and send interrupts to the supervisory process when an environmental change is detected.

As another example, the most recent state is described as being loaded at power up (step 85), prior to determining (at step 95) whether a mismatch between the most recent and current environments dictates loading a different state. In some embodiments, the device can load the most recent state into its registers and memory after determining that the environment had not changed (i.e., between steps 95 and 100).

As another example, there are at least two instances where user prompts are described. These can be eliminated or can be provided by a user preference. Where no user prompts were being provided, the default can be for the device to remain in the same state if no previously stored state is found at step 105, i.e., fall through to step 100. Thus the device would depend on the user affirmatively setting up saved states for specific or designated environments.

Thus there are various design choices regarding when changes to the machine state or to the designated environments should be saved. Embodiments of the present invention are intended to enhance the user experience, but what might be an enhancement for some users might be seen as an inconvenience to another. Thus embodiments of the invention can provide the user options as to whether to provide prompts or not. Similarly, the user can be provided the opportunity to choose which types of environmental changes are to result in a state change.

The flowchart of FIG. 3 does not explicitly show what happens in the case of a sensed power down or suspension of operation. The normal course of action can be to save the state and environment of the device, and bring up the saved state and environment on the next power up or resumption of operation. However, as discussed above, on the next power up or resumption, the device will check the current environment and allow for the possibility of changing the machine state to one designated by the user to be associated with a different environment.

Some simple examples are provided for clarity. In a first set of examples, the environment is characterized by the PMD being connected to, or disconnected from, a given speaker system (such as a car audio system). In the specific example where the PMD is an iPod® device, some accessories can identify themselves using a serial protocol when they connect. The iPod® device can use this identification to determine what is connected. The examples differ on the relevant state parameters that are affected.

Consider where the relevant state parameters include the current track or playlist. When the PMD is turned off or removed from the speaker system, the information regarding the track that was playing is saved along with other possible state parameters. When the PMD is again connected to the speaker system, it can resume playing from the track or playlist it was last playing when connected to the speaker system. In some embodiments, it can resume playing at the same place in the track. This is despite the fact that the PMD might have since been used in one or more different environments and been used to play entirely different music.

In a like manner, when the PMD was first connected to the speaker system, the previous information regarding the track that was playing was first saved along with other possible state parameters before loading the state that was saved when the PMD was removed from the speaker system.

Consider where the relevant state parameters include volume-related parameters. When the PMD is connected to the speaker system, the line out level can be set to a fixed value (e.g., 70%). Alternatively, or in addition, the PMD volume controls can be disabled. These actions can depend on the particular properties of the speaker accessory, and possibly on user preferences.

As mentioned above, machine context is one of the status parameters. In some iPod® embodiments, a “Speakers” menu item appears when the PMD is coupled to certain types of accessory speakers. In some embodiments, the device can switch to a Speakers menu mode when the accessory is detected, giving the user instant access to the Speakers menu settings, which would otherwise only be available when the user manually invoked the Speakers menu item.

Another set of examples includes instances where the environment is characterized by physical location, either provided by a GPS receiver in the PMD or some other location-sensing technique (e.g., triangulation using cellular signals). The user can specify particular playlists and maximum volume depending on whether the user was in the car, at home, or at work. In this example, the fact that the user was in the car can also be detected by the fact that the PMD was connected to a car's audio system.

In a similar manner, the environment may be characterized by physical location and the nature of possibly attached accessories. In any event, the device can detect the environment on the basis of signals provided by one or more entities outside the device, and generate identifying information. The identifying information can be thought of as providing values for one or more environmental parameters, and the device characterizes its current environment on the basis of the values of these environmental parameters.

Another set of examples includes instances where the environment is characterized by the state of wireless communications. To the extent that the PMD is not natively enabled for a particular wireless protocol, the environmental change could in the first instance be detected by a wired connection (e.g., via accessory interface connector 35) with a wireless adapter.

These examples include instances where the PMD detects a wireless (e.g., Bluetooth) pairing with a wireless-enabled accessory. For example, a possible accessory kit can include the combination of a wireless sensor (e.g., a piezoelectric accelerometer) that is designed to fit into a user's shoe, and a complementary wireless receiver. In response to detecting the presence of the receiver, the PMD can automatically select a playlist suitable for the user's physical workout. The PMD can also switch to a mode where it provides workout-related parameters such as previous performance statistics.

These examples also include instances where the PMD detects a wireless signal that, in effect, directs the PMD to access a previously stored audio file (e.g., podcast) dealing with the subject matter encoded into the wireless signal. For example, a number of museums (and other public buildings of interest such as libraries) encourage patrons to download podcasts to their PMDs, and then play the podcast, which can provide museum-related information such as might normally be provided by a live tour guide or a museum-provided audio tour player.

In one implementation, upon detecting that the user had entered into range of the museum's wireless broadcast, the PMD could present a “playlist” with the various museum locations as “tracks” for the user to play depending on the user's choice of locations to visit. In another implementation, the museum could provide short-range wireless signals at different locations, and the PMD could sense a particular location's signal and commence playing a relevant portion of the previously stored audio material.

These examples also include instances, at least for PMDs capable of downloading content wirelessly or decoding and playing streaming content, where the PMD detects a wireless signal that contains the content to be played. The PMD can then change its state parameters to accommodate the wireless content, either by downloading it or playing it.

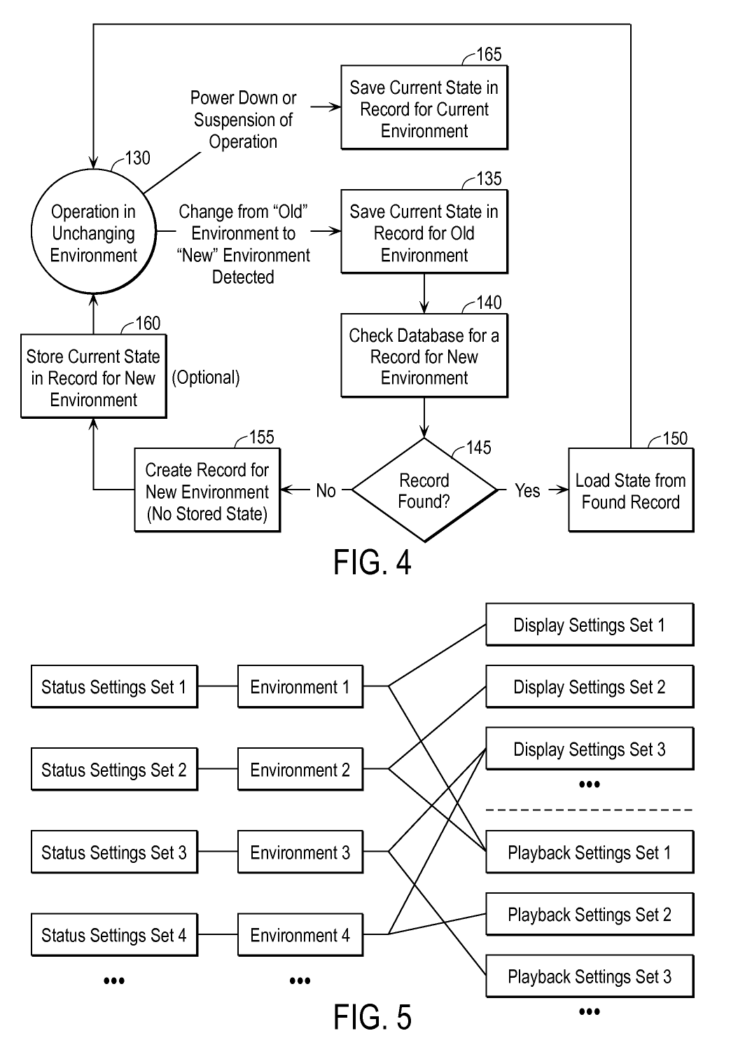

FIG. 4 is a flowchart showing additional scenarios that can occur during operation of an embodiment of the present invention. These embodiments operate in the context where state data 60 is organized in a database. The flowchart in FIG. 4 represent embodiments where previously saved states are automatically loaded and states are automatically saved when a different environment is detected.

In FIG. 4, the top left corner shows a node 130 signifying operation during a time period where the environment (referred to as the old environment) is not changing. This could be implemented with a loop similar to loop 120 in FIG. 3, or by any other mechanism (e.g., an interrupt) that would signify the detection of a change to a new environment.

When a change in the environment is detected, at a step 135, the current state parameters are saved in the database record for the old environment. At a step 140, the database is checked to determine whether there is a record for the new environment. If such a record is found, a branch 145 causes the state parameters found in the record for the new environment to be loaded at a step 150, and the device then returns to node 130 where operation according to the state loaded in step 150 occurs. At this point the “new” environment becomes the old environment for purposes of subsequent changes in environment.

On the other hand, if no record for the new environment is found at step 140, branch 145 causes the creation, at a step 155, of a new database record for the new environment. In some embodiments, at a step 160 the current state parameters can be stored in the just-created record, and the device then returns to node 130. While steps 155 and 160 are shown as separate steps, this is only one example. For example, it is also possible to store the state parameters in a predetermined known manner, and then create an association of the environment with the stored parameters.

Since the time interval between step 135 and step 160 (if performed) is very short, the record for the old environment and the record for the new environment may contain the same settings parameters (and possibly the same status parameters). The state parameters will be subsequently changed if and when the user changes one or more settings parameters or the operation of the device (inherently or by user action) causes one or more status parameters to be changed. These changes can be saved in the database while the device is operating as signified by node 130. In any event, to the extent that the state parameters change before the next change in environment, the changed state parameters will be saved in the database at step 135 after the next environment change.

In the above description it was assumed that by the time the device is operating as signified by node 130 there is a database record associated with the old environment. If for some reason this were not the case, execution of step 155 and possibly step 160 after branch 145 will cause a record to be created (possibly including the then-current state parameters associated with the then-current environment).

FIG. 4 also shows the possibility that a power down or suspension of operation will be detected when the device is operating as signified by node 130. In this case, at a step 165, the current state parameters are saved in the database record for the most recent environment. In this context, the record for the most recent environment is the record that was found at step 140 or created at step 155.

As mentioned above, step 160 is optional. Thus, it is possible to create the database record for the new environment without storing any state parameters. The reason for this is that the device will continue to operate with the state parameters that are in effect anyway, and that these state parameters, which are possibly modified before the next environment change or power down, will be saved in one or the other of steps 135 and 165. Accordingly, it is possible to proceed directly from step 155 to node 130.

As mentioned above, the schematic view of FIG. 1A, which resembles a spreadsheet or a flat-file database, is but one way to organize the state data. At least some embodiments share the characteristic that the stored state data can be searched to determine whether there is a stored state (i.e., a set of state parameters) associated with a particular environment (i.e., a set of values of environmental parameters). The present invention is not limited to any particular database arrangement, and the environments and states can be stored in a manner that does not follow normal database designs. For example, the state data (environments and states) could be stored in an XML document or the like.

Various types of data structures such as lists, graphs, and trees can be used. Similarly, the data stored at various locations can take various forms such as arrays, records, discriminated unions, and references. It is not necessary to store environments explicitly, but at least some embodiments use a mechanism to determine whether a current environment matches a previously encountered environment that was associated with stored state information.

In the embodiments described above, a given environment maps to a single set of state parameters. That does not mean to say, however, that the database needs to be organized as a single table, even though it could be. In this embodiment, multiple environments can map to a the same set of state parameters, depending on how the user has specified settings at different times. In some situations, there will be considerable commonality among the different saved states, at least as to the settings information portion of the state information. In some situations, the status information will be quite different for the different states due to the more transitory nature of the status parameters.

Furthermore, even for a given logical organization of the database, there can be many physical ways to implement it. Hash tables or various types of tree structures (such as binary trees, tries—also known as prefix trees, and PATRICIA trees) can be used to match an environment and thereby retrieve a stored state associated with the matched environment. As a practical matter, the number of environments is not likely to be very large, especially for embodiments where the only environmental parameter is the accessory identifier. Even though a given user may only have a handful of different accessories, the manufacturer can, if it wishes, pre-populate the database with records for a wide array of accessories, for example with settings recommended by the accessory manufacturers. The PMD manufacturer or the accessory manufacturer can provide updated sets of settings that users could download and install.

FIG. 5 is a simplified schematic of a possible database arrangement for an embodiment of the present invention. In this figure, there are four environments, and each is shown as associated with a respective distinct set of status settings. However, in this arrangement, the settings parameters are broken up into display settings and playback settings, as a representative breakdown. As the settings are broken down, it becomes increasingly likely that multiple environments can be associated with the same values for the display settings parameters or the playback settings parameters. This is shown schematically as three sets of display settings values and three sets of playback settings parameters being shared among four environments.

In this arrangement, each environment is associated with uniquely determinable state information, notwithstanding that multiple environments can share portions of the overall state data. Thus, it can still be said that each environment has a determinable associated state information construct. That is, while separate states are stored in data storage subsystem 50, the possible sharing means that the different states are not necessarily stored in disjoint portions of the storage subsystem.

In this type of arrangement, when a user changes, for example, one of the display settings parameter values, the environment can disassociate from the originally associated set of display settings information and a new set of display settings information can be stored when the state is saved. A variation on this is to determine whether the new set of display settings information corresponds to an existing set, and if so, the environment can associate with the already existing set. Over time, as settings information changes, some of the stored sets of settings information can become orphaned in the sense that they are no longer associated with any environment. At that point, they can be deleted from storage.

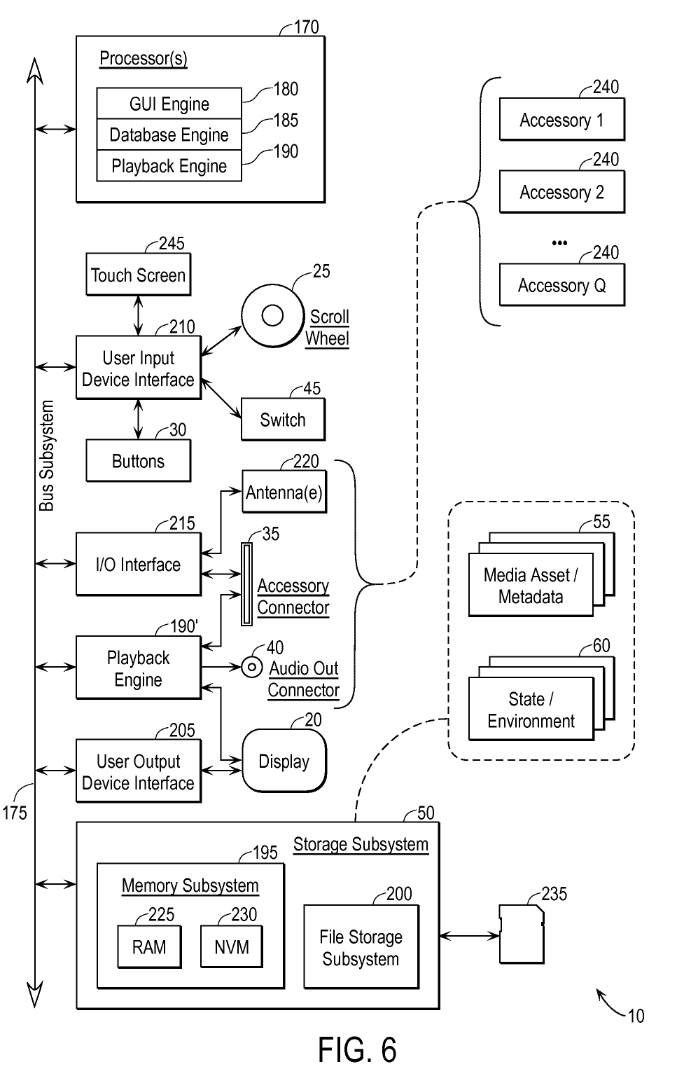

FIG. 6 is a block diagram of a device according to an embodiment of the present invention. For concreteness, the example of PMD 10 will be used, it being understood that PMDs and other devices according to embodiments of the present invention do not need to contain all the components shown, and further that they may contain additional components. Again for concreteness, the description of PMD 10 will be in terms of a device that, among other things, plays music.

PMD 10 is preferably processor-based, and to that end typically includes at least one processor 170, which can be a conventional microprocessor or microcontroller. The processor can communicate with a number of peripheral devices via a bus subsystem 175. The processor is shown as implementing a graphical user interface (“GUI”) engine 180, a database engine 185, and a playback engine 190. Bus subsystem 175 provides a mechanism for letting the various components and subsystems of PMD 10 communicate with each other as intended. Although bus subsystem 175 is shown schematically as a single bus, embodiments of the bus subsystem may utilize multiple buses, and various of the components may have private connections. Although the specifically described embodiments are processor-based embodiments, other embodiments can be implemented with other types of controllers such as combinatorial logic.

In addition to storage subsystem 50, which is shown as having a memory subsystem 195 and a file storage subsystem 200, the devices on the bus can include various interface controllers for interfacing to other devices or functional elements that do not interface to other devices. In the representative configuration shown in FIG. 6, the additional devices include a user output device interface 205 (shown coupled to coupled to display 20), a user input device interface 210 (shown coupled to scroll wheel 25, buttons 30, and switch 45), an I/O interface 215 (shown coupled to accessory interface connector 35 and one or more antenna(e) 220), and an optional dedicated playback engine 190′.

Embodiments of the invention can be implemented with many different types of processor. Many PMDs use an embedded processor such as processors using the ARM architecture (a RISC architecture designed by ARM Limited).

GUI engine 180, database engine 185, and playback engine 190 can be implemented, for example, in program code (software or firmware) stored in PMD 10 and running on a processor such one of processors 170, in hardware, or in combinations of the two. Database engine 185, which can be of conventional design, provides various capabilities related to searching, browsing, and selecting assets 65 or groups of assets 65 from storage subsystem 50. Playback engine 190, which can also be of conventional design, provides capabilities related to presenting selected media assets 65 from storage subsystem 50 to a user. In some embodiments, playback engine 190 may provide video portions of media assets 65 and/or audio portions of media assets 65 to the user. In some embodiments, the playback engine can provide USB digital audio as well as analog audio.

FIG. 6 shows dedicated playback engine 190′; while the playback functionality can be implemented in software by processor(s) 170, as described above, some embodiments may have a dedicated playback engine coupled to audio out connector 40. Dedicated playback engine 190′ provides decoding of encoded audio files (e.g., MP3, AAC) and digital-to-analog conversion for output at audio out connector 40. For a specific embodiment where the analog audio out signal is provided to accessories through accessory interface connector 35, the playback engine is also coupled to accessory interface connector 35. Conversely, for embodiments where there is no dedicated playback engine, I/O interface 215 can be provided with digital-to-analog conversion capability to drive audio out connector 40.

Storage subsystem 50 can include various types of storage media, and stores the basic programming and data constructs that provide at least some of the functionality of PMD 10 For example, the various program modules and databases implementing the functionality of the PMD may be stored in storage subsystem 50. The software modules are generally executed by processor(s) 170. In the case of a PMD, the storage subsystem is used to store media assets 65, which may account for a significant portion of the overall storage capacity. In embodiments of the present invention, the storage subsystem is also used to store multiple device states 75.

Memory subsystem 195 typically includes a number of memories including a main random access memory (RAM) 225 for storage of instructions and data during program execution and a non-volatile memory (NVM) 230 in which fixed instructions and fixed system parameters are stored. While the non-volatile memory may be a ROM, rewritable non-volatile memories such as flash EPROMs may be used.

File storage subsystem 200 provides persistent (non-volatile) storage for program and data files, and may include one or hard disk drives and/or flash memory drives. Additionally the file storage subsystem may support associated removable media 235, e.g., flash memory cards such as those used in digital cameras and mobile phones. Possible types of flash memory cards include but are not limited to Secure Digital (SD), CompactFlash (CF), Memory Stick (MS), MultiMediaCard (MMC) xD-Picture Card (xD), and SmartMedia (SM).

In some embodiments, some of the media assets, or portions thereof that are stored in file storage subsystem 200 are transferred to a cache in memory subsystem 195, and then read out from the cache by playback engine 190. Transferring significant portions of a media stream to memory before playback can provide a measure of skip protection for hard-drive-based PMDs, and also provides the benefit of allowing the disk drive to be turned off while media are read out from the memory.

I/O interface 215 operates, for wired connections, to provide output signals and receive input signals to and from connectors outside housing 15 such as accessory interface connector 35 and audio out connector 40. The I/O interface operates, for wireless connections to provide output signals and receive input signals by use of antenna(e) 220. A number of accessories 240, designated Accessory(1) . . . Accessory(Q) are shown coupled to the I/O interface. Accessories 240 can provide additional functionality, and can include such items as earphones, external speakers, microphones, car stereo adapters, wireless adapters, and the like. The connections between the I/O interface and the accessories can be via one or more intermediate elements such as a dock. I/O interface 215 in possible combinations with interface connector 35 and/or antenna(e) 220 represent possible instances of interface 2a shown in FIGS. 1A-1D.

Embodiments of the present invention are not limited to any particular way that a device detects the connection to an accessory, and the possible identification of a connected accessory. However, for concreteness, an exemplary technique is described. Some accessories can include identification hardware and/or software (collectively “identification elements”), where the hardware can include passive and/or active circuitry depending on the accessory and the identification protocol. For example, some accessories can include primary identification elements and secondary identification elements.

In some embodiments, the primary identification elements include a set of resistors that present a predetermined resistor value to the PMD when enabled, which can indicate, for example, that the accessory has secondary identification elements that can communicate according to a particular protocol (e.g., a particular serial protocol) and provide accessory identifier information.

In an exemplary implementation, the PMD detects the presence of an accessory in response to the extended identification resistor value created by the primary identification elements in the accessory and further detects on this basis that the accessory has secondary identification elements. At this point, the PMD can initiate a sequence of communications with the accessory's secondary identification elements to obtain the accessory identifier information.

I/O interface 215 may include one or more peripheral interfaces such as USB, IEEE 1394 (Firewire), and Bluetooth (a short-range wireless communication standard developed by the Bluetooth SIG and licensed under the trademark Bluetooth®). The I/O interface may also or alternatively include one or more wired networking interfaces (e.g., Ethernet) or wireless networking interfaces (e.g., Wi-Fi adhering to one of the 802.11 family standards, digital mobile phone technologies). Thus, depending on the embodiment, I/O interface 215 can provide an interface to one or more host computers, one or more networks, or accessories coupled to PMD 10. The I/O subsystem need not be configured for all these possibilities; it can be very limited in scope for some embodiments.

For example, the I/O subsystem of some embodiments may have the ability to couple PMD 10 to a host computer (via a wired or wireless connection) that provides additional asset management capabilities as can be provided by an MMA. Such asset management capabilities include but are not limited to storing additional assets 65 in storage subsystem 50, removing assets 65 from storage subsystem 50 and/or organizing assets in manners that facilitate desired uses. For example, music assets can be arranged into playlists.

As another example, the I/O subsystem of some embodiments (possibly the same as those above, but possibly different embodiments) will have the ability to couple PMD 10 with a source of media assets (e.g., via a wireless connection to the Internet) so that the PMD can obtain media assets without connecting to a host computer. As another example, the I/O subsystem of some embodiments (possibly the same as those above, but possibly different embodiments) will have the ability to couple PMD 10 to accessories that expand the capabilities of the PMD (e.g., via accessory interface connector 35 or antenna(e) 220).

As another example, the I/O subsystem of some embodiments (possibly the same as those above, but possibly different embodiments) will have the ability to couple PMD 10 to sources of wireless signals that allow the PMD to determine its location. Wireless signals from global positioning satellites can be used for those PMDs that include a GPS receiver. Alternatively, wireless signals from one or more cellular towers can be used by those PMDs that had the ability to triangulate or otherwise decode such signals.

In addition to, or instead of, scroll wheel 25 and buttons 30, the user input devices coupled to user input device interface 210 may include one or more of any or all of the following: keyboards; pointing devices such as mice, trackballs, touchpads, or graphics tablets; scanners, barcode scanners; touchscreens incorporated into displays; audio input devices such as voice recognition systems, microphones, and other types of input devices. In general, use of the term “user input device” is intended to include all possible types of devices and ways for a user to input information into PMD 10. It is noted that some of the above-mentioned user input devices can be coupled to I/O interface 215 through accessory interface connector 35.

In the context of a typical PMD, the input devices can include such devices as a touch screen 245, a scroll wheel such as scroll wheel 25 in FIG. 1A, buttons such as buttons 30 shown in FIG. 1A, knobs, and the like to receive user input. On a PMD such as some versions of the iPod®, the user may invoke scrolling by touching a scroll wheel and moving a finger in a circular motion. At different times, the scroll wheel has been implemented as an actual rotatable member, or as a series of fixed capacitive sensors disposed under a fixed annular region of the PMD body, which the user “moves” by touching and moving a finger in a circular motion. PMDs and computers with touch interfaces allow various gestures to cause scrolling.

Additional types of input devices could be motion detectors such as accelerometers that can respond to a user's actually moving the device. In the case of a portable device, for example, a clockwise (or counterclockwise) twist of the wrist can be interpreted in a manner analogous to a clockwise (or counterclockwise) actuation of a scroll wheel or a knob. Similarly, while the exemplary input devices were generally described as being mounted to or associated with the PMD or computer, reference to exemplary input devices should be considered to include such devices mounted to or associated with a remote control device. Remote control devices can include wired (tethered) devices (e.g., connected to user input device interface 210 or I/O interface 215, possibly using the accessory connector) and wireless devices communicating via one of antenna(e) 220.

In FIG. 6, the only user output device coupled to user output device interface 205 is a display. The present invention does not rely on any particular type of display, although suitable candidates can include liquid crystal displays (LCDs) or light emitting diode (LED) displays. Some PMDs can also provide non-visual display such as audio output. In general, use of the term “user output device” is intended to include all possible types of devices and ways to output information from PMD 10 to a user. In typical PMDs, the primary display is a visual display, which is used to display visual characteristics of the media assets (e.g., in the case of videos, images, and the like) and metadata (perhaps displayed in lists or in hierarchical menus).

GUI engine 180 can interact with display 20 and user input devices such as scroll wheel 25 and buttons 30 to provide a graphical user interface, allowing a user to control operation of PMD 10. GUI engine 180 can control display 20 to present user interface elements such as text menus, icons or the like, and user input devices can be operated by a user to interact with the displayed user interface elements (e.g., selecting or activating an element, thereby giving an instruction to PMD 10).

In some embodiments, user input devices can include a touch-sensitive element overlaying display 20, providing a touch screen interface. In other embodiments, user input devices can include distinct devices such as one or more of a scroll wheel 25, buttons 30, a touch pad. In any event, GUI engine 180 can reflect the operation of user input device(s) by updating display 20, e.g., to change which item on a menu is highlighted for selection. The GUI can enable the user to control any aspect of PMD 10, including locating and selecting media assets 65 to be played, controlling playback (e.g., play, pause, fast forward, rewind, etc.), adjusting playback settings (volume, equalizer, etc.), and so on.

A significant aspect of the user output are the sound characteristics of the assets, such as the music or words of audio tracks and the soundtrack of videos. As such, some of the embodiments of the invention are concerned with facilitating the playback of music.

In conclusion can be seen that embodiments of the present invention provide additional functionality that can enhance user experience and convenience when using devices such as PMDs.

While the above is a complete description of specific embodiments of the invention, the above description should not be taken as limiting the scope of the invention as defined by the claims.

1. A method of establishing an operating state of a portable device, the method comprising:
receiving, at an interface of the device, a non-power signal provided by an entity outside the device, the signal containing identifying information; and
in response to the signal, using the identifying information to determine whether there exists previously stored state information that is associated with information matching the identifying information.

2. The method of claim 1 wherein:
the signal is received from an accessory coupled to the interface of the device; and
the identifying information includes a characteristic of the accessory.

3. The method of claim 1 wherein:
the signal is received from an accessory having a wireless transmitter; and
the identifying information includes a characteristic of the accessory.

4. The method of claim 1 wherein:
the signal is received from one or more remote wireless transmitters; and
the identifying information includes information that provides the device the ability to determine the device's location.

5. The method of claim 1 wherein:
the signal is received from a wireless network; and
the identifying information includes a characteristic of the network.

6. The method of claim 1 wherein the operating state is characterized by a set of state parameters that includes:
at least one settings parameter whose value is user-settable; and
at least one status parameter whose value is inherently determined by the way that the device is being currently used.

7. The method of claim 1 wherein:
the device is a portable media device; and
the operating state is characterized by one or more state parameters including at least one parameter relating to audio output.

8. The method of claim 1, and further comprising:
in response to determining that there exists previously stored state information that had been associated with information matching the identifying information, reconfiguring the device in accordance with the stored state information.

9. The method of claim 1, and further comprising:
in response to determining that there does not exist previously stored state information that had been associated with information matching the identifying information, storing current state information in association with information matching the identifying information.

10. A method performed by a device, the device being capable of determining an environment, the method comprising:
determining a current environment for the device;
determining whether the current environment matches a most recently stored environment;
if no, then
(a) determining whether there is stored state information that is associated with the current environment, and
(b) if there is stored state information, reconfiguring the device in accordance with the stored state information that is associated with the current environment.

11. The method of claim 10, and further comprising:
if it is determined that there is no stored state information that is associated with the current environment, then
prompting the user whether to associate state information with the current environment, and
(a) if the user specifies associating state information with the current environment, storing state information in association with the current environment, or
(b) if the user specifies not associating state information with the current environment, maintaining the current state without storing state information associated with the current environment.

12. The method of claim 10, and further comprising, in response to a user action specifying a new value for a state parameter, saving new state information as associated with the current environment.

13. The method of claim 10 wherein the current environment is characterized by a set of one or more environmental parameters, and determining a current environment for the device comprises:
detecting signals at an interface of the device;
determining whether there is an accessory coupled to the interface; and
if there is an accessory coupled to the interface, incorporating information about the accessory into at least one environmental parameter.

14. The method of claim 10 wherein the current environment is characterized by a set of one or more environmental parameters, and determining a current environment for the device comprises:
detecting wireless signals from one or more remote wireless transmitters at an antenna of the device;
determining whether the wireless signals contain information that provides the device the ability to determine the device's location; and
if the wireless signals provide such information, incorporating information about the device's location into at least one environmental parameter.

15. The method of claim 10 wherein the current environment is characterized by a set of one or more environmental parameters, and determining a current environment for the device comprises:
detecting wireless signals from one or more remote wireless transmitters at an antenna of the device;
determining whether the wireless signals contain information regarding a wireless network; and
if the wireless signals provide such information, incorporating information about the wireless network into at least one environmental parameter.

16. The method of claim 10 wherein the state information is characterized by a set of state parameters that includes:
at least one settings parameter whose value is user-settable; and
at least one status parameter whose value is inherently determined by the way that the device is being currently used.

17. The method of claim 10 wherein:
the device is a portable media device; and
the state information is characterized by one or more state parameters including at least one parameter relating to audio output.

18. A method of establishing an operating state of a device, the operating state being characterized by a set of one or more state parameters, the method comprising:
while in a current operating state, in response to detecting the presence of an accessory coupled to an accessory interface of the device, determining identifying information that characterizes the accessory;
using the identifying information to determine whether there exists a previously stored operating state that had been associated with information matching the identifying information; and
in response to determining the existence of such a previously stored operating state, changing at least those state parameters that differ between the current operating state and the previously stored operating state.

19. A portable device comprising:
a storage medium;
a processor coupled to said storage medium;
an interface for receiving non-power signals provided by entities outside the device, the signals containing identifying information;
a plurality of state information constructs stored in said storage medium, said state information constructs representing operating states for the device, each state information construct being associated with one or more sets of identifying information; and
computer code stored in said storage medium wherein said computer code, when retrieved from said storage medium and executed by said processor:
uses identifying information in signals at said interface to determine whether any state information constructs in said storage medium are associated with information matching the identifying information.

20-25. (canceled)

26. The device of claim 19 wherein said computer code, when executed by said processor further:
in response to determining that said storage medium includes one or more state information constructs that are associated with information matching the identifying information, reconfigures the device's operating state in accordance with at least a state parameter value stored in one or more of those one or more state information constructs.

27. The device of claim 19 wherein said computer code, when executed by said processor further:
in response to determining that said storage medium does not include one or more state information constructs that are associated with information matching the identifying information,
creates a state information construct with at least one state parameter value corresponding to a current operating state, and
associates that state information construct with information matching the identifying information.

28. A device comprising:
a storage medium;
an interface for receiving non-power signals provided by entities outside the device;
state information stored in said storage medium, said state information representing a plurality of device operating states associated with a plurality of device environments;
a controller coupled to said storage medium, the controller being configured to:
determine, based on non-power signals received at said interface, a current environment for the device;
determine whether the current environment matches a most recently stored environment; and
if the current environment does not match the most recently stored environment, then
determine whether there is stored state information that is associated with the current environment, and
if it is determined that there is stored state information that is associated with the current environment, reconfigure the device in accordance with the stored state information that is associated with the current environment.

29. The device of claim 28 wherein said controller is further configured, if it is determined that there is no stored state information that is associated with the current environment, to:
prompt the user whether to associate state information with the current environment, and
if the user specifies associating state information with the current environment,
store state information in association with the current environment,
if the user does not specify associating state information with the current environment,
maintain the current state without storing state information associated with the current environment.

30. The device of claim 28 wherein said controller is further configured, in response to a user action specifying a new value for a state parameter, to save new state information as being associated with the current environment.

31-35. (canceled)

36. A portable media device having operating states, an operating state being characterized by a set of one or more state parameters, the device comprising:
a storage medium;
an interface for receiving non-power signals provided by entities outside the device;
state information stored in said storage medium, said state information representing a plurality of device operating states associated with a plurality of device environments;
a controller coupled to said storage medium, the controller being configured to:
while in a current operating state, in response to detecting the presence of an accessory coupled to an accessory interface of the device, determine identifying information that characterizes the accessory;
use the identifying information to determine whether there exists a previously stored operating state that had been associated with information matching the identifying information; and
in response to determining the existence of such a previously stored operating state, change at least those state parameters that differ between the current operating state and the previously stored operating state.

37-43. (canceled)

44. The computer-readable medium of claim 37 wherein the method executed by the computer system further comprises:
in response to determining that there exists previously stored state information that had been associated with information matching the identifying information, reconfiguring the device in accordance with the stored state information.
in response to determining that there does not exist previously stored state information that had been associated with information matching the identifying information, storing current state information in association with information matching the identifying information.

45. A computer-readable medium containing program instructions, which when executed by a computer system in a portable device capable of determining an environment cause the computer system to execute a method of establishing an operating state of the portable device, the method comprising:
determining a current environment for the device;
determining whether the current environment matches a most recently stored environment;
if no, then
(a) determining whether there is stored state information that is associated with the current environment, and
(b) if there is stored state information, reconfiguring the device in accordance with the stored state information that is associated with the current environment.

46. The computer-readable medium of claim 45 wherein the method executed by the computer system further comprises:
if it is determined that there is no stored state information that is associated with the current environment, then
prompting the user whether to associate state information with the current environment, and
(a) if the user specifies associating state information with the current environment, storing state information in association with the current environment, or
(b) if the user specifies not associating state information with the current environment, maintaining the current state without storing state information associated with the current environment.

47. The computer-readable medium of claim 45 wherein the method executed by the computer system further comprises, in response to a user action specifying a new value for a state parameter, saving new state information as associated with the current environment.

48-53. (canceled)
